(19) United States
(12) Patent Application Publication
(10) Pub. No.: US 2007/0173265 A1
(43) Pub. Date: Jul. 26, 2007

(54) METHOD AND APPARATUS FOR SETTING THE BOUNDARIES OF VIRTUAL OPERATIONS

(76) Inventor: Arnold Jason Gum, San Diego, CA (US)

Correspondence Address: QUALCOMM INCORPORATED, 5775 MOREHOUSE DR., SAN DIEGO, CA, 92121, US

(21) Appl. No.: 11/623,579

(22) Filed: Jan. 16, 2007

Related U.S. Application Data
(60) Provisional application No. 60/759,800, filed on Jan. 17, 2006.

(51) Int. Cl. H04Q 7/20

(52) U.S. Cl. 455/456.1

(57) ABSTRACT

A wireless communications device with positioning capabilities is used to mark a boundary of a virtual operations area, and used to mark one or more obstacles within the boundary. Virtual operations may be conducted by users having a wireless communications device, and the wireless communications device generates an alert when a user violates the boundary or is within a preset proximity to an obstacle.

### CROSS REFERENCE TO RELATED APPLICATIONS

The present Application for Patent claims priority to Provisional Application No. 60/759,800 entitled “Method and Apparatus for Setting the Boundaries of Virtual Operations Via GPS” filed Jan. 17, 2006, and assigned to the assignee hereof and hereby expressly incorporated by reference herein.

### BACKGROUND

1. Field

The present invention relates generally to location tracking in wireless communication devices. More particularly, the present invention relates to marking boundaries for virtual operation and marking obstacles within the boundaries using a location tracking application in a wireless communication device.

2. Background

Virtual reality games often place a user in a role playing situation, in which the user takes on the role of a character in the game. Traditionally, such games, such as video games and/or board games are played at fixed locations. Such fixed locations may be a computer screen, or some other type of computerized interface in which the user is confined to a relatively small area. Similarly, in games that involve a playing board, the user is also confined to a relatively small area, at least during the duration of the user's turn. For example, in role playing games such as Dungeons and Dragons, players gather and take turns and attempt to gather virtual items or points that the player may use to create a character having differing capabilities, that the player then uses to advance through the game. Such games typically are played in a room or indoors, and often last several hours for each game playing session.

As has been recognized, such role playing games, or other games, would be conducive to playing in a relatively large playing area, such as a field, in which the players could move around the playing area, encounter different virtual obstacles, and take actions in response to the different obstacles. However, the problem of imparting a virtual reality area upon the physical world has not been solved.

Furthermore, many other activities which are played outdoors are played within a defined playing area. For example, a soccer game is typically played within a boundary that is identified by the boundaries of the soccer field. Such games are commonly played by young children, and parents typically do not want the children leaving the grounds of the playing area, or relatively close proximity thereto, unattended. Therefore, there is a need in the art for a method and apparatus for setting boundaries and marking the positions of obstacles associated with the boundaries for such applications.

### SUMMARY

Embodiments disclosed herein address the above stated needs by providing methods and systems for setting boundaries and marking the positions of obstacles associated with the boundaries. Boundaries may be set using a wireless communications device that is capable of providing positioning information, with the positioning information used to set the boundaries and mark obstacle positions.

In one aspect, a method for setting virtual representations of an area for conducting virtual operations is provided. The method of this aspect comprises: (a) setting boundaries of an area with a wireless communications device enabled with location determination capabilities; and (b) marking the position of at least one obstacle in the area with the wireless communications device. The wireless communications device may include location determination capabilities that utilize a satellite positioning system such as a global positioning system receiver. The wireless communications device may also transmit the boundaries of the area and the position of the at least one obstacle to a server. Boundaries may be set in any of a number of ways, such as marking corners of quadrangle shaped boundaries, marking a center point of a boundary that has known dimensions to the center point, and marking two or more points and designating a relationship between the marked points and the area, to name but a few examples. Obstacles may be marked by marking the position of an obstacle when the wireless communications device is located in proximity to the obstacle and designating a size of the obstacle, for example.

Another aspect of the present disclosure provides a server apparatus, comprising: (a) a network interface to transmit/receive network communications signals to/from one or more base stations; and (b) a controller operable to receive information from the network interface from one or more wireless communications devices enabled with location determination capabilities, the information from the wireless communications device including location information along with information indicative of an area for virtual operations, the location information including information related to a boundary of the area and at least one exception associated with the area boundary. The server is operable to receive location information from the wireless communications device along with information indicative of an area for the virtual operations, the location information including information related to a boundary of the area and at least one exception associated with the area boundary.

Still another aspect of the present disclosure provides a wireless communications device that may be used for setting boundaries and marking obstacles. The wireless communications device comprising (a) a location determination subsystem; (b) a controller processor operably interconnected to the location determination subsystem; and (c) a memory operably interconnected to the controller processor. The controller processor is operable to run an application stored in the memory, the application determining the location of the wireless communications device based on the location determination subsystem, marking a boundary of an area for virtual operations, and marking at least one obstacle or exception within the boundary. The controller processor may calculate boundary and obstacle information, or may transmit the location information to a server and receive boundary and obstacle information from the server. The controller processor may also periodically transmit location information from the location determination subsystem to the server when conducting virtual operations, and receive instruction from the server in response to the transmission of location information.

### BRIEF DESCRIPTION OF THE DRAWINGS

FIG. 1 is a diagram of a site at which a virtual reality game is to be played;

FIG. 2 is a diagram of a wireless communications device located at a corner of a playing area boundary of the site;

FIG. 3 is an illustration of the site and the wireless communications device located at a different point of the playing area boundary;

FIG. 4 is a block diagram illustration of a wireless communications device of an exemplary embodiment;

FIG. 5 is a block diagram illustration of a wireless communications device and a server of an exemplary embodiment;

FIG. 6 is a block diagram illustration of a server of an exemplary embodiment;

FIG. 7 is a diagram of an example of a site having a playing area and having a boundary around a proximity of the playing area;

FIG. 8 is a flow chart illustrating the operational steps of boundary and obstacle determination for an exemplary embodiment;

FIG. 9 is a flow chart illustrating the operational steps of obstacle determination and definition for an exemplary embodiment; and

FIG. 10 is a flow chart illustrating the operational steps of boundary and obstacle determination for an exemplary embodiment;

FIG. 11 is a flow chart of the operational steps of boundary and exception information determination of an exemplary embodiment; and

FIG. 12 is a flow chart illustrating the operational steps of a server of one exemplary embodiment.

### DETAILED DESCRIPTION

For a more complete understanding of this invention, reference is now made to the following detailed description of several embodiments as illustrated in the drawing figures, in which like numbers represent the same or similar elements.

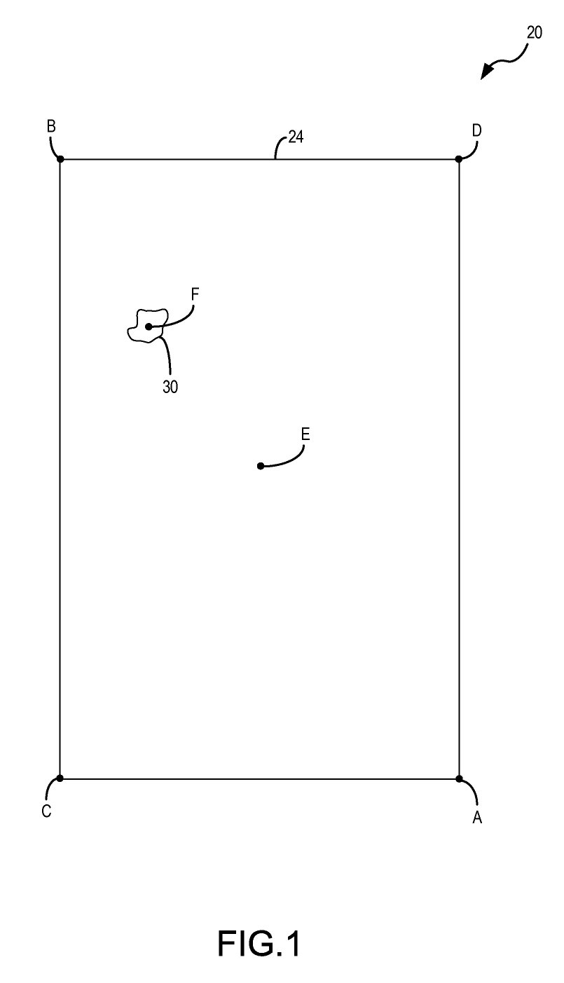

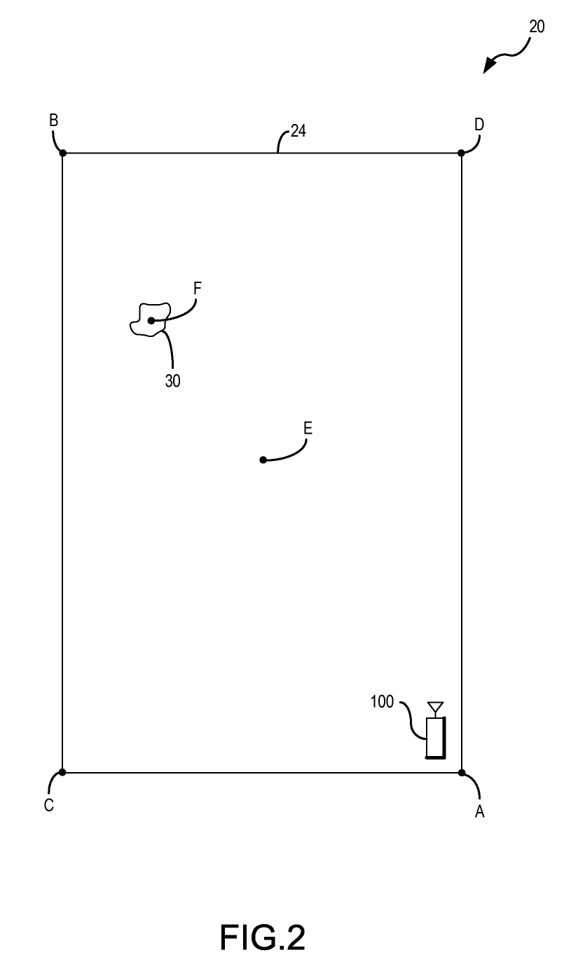

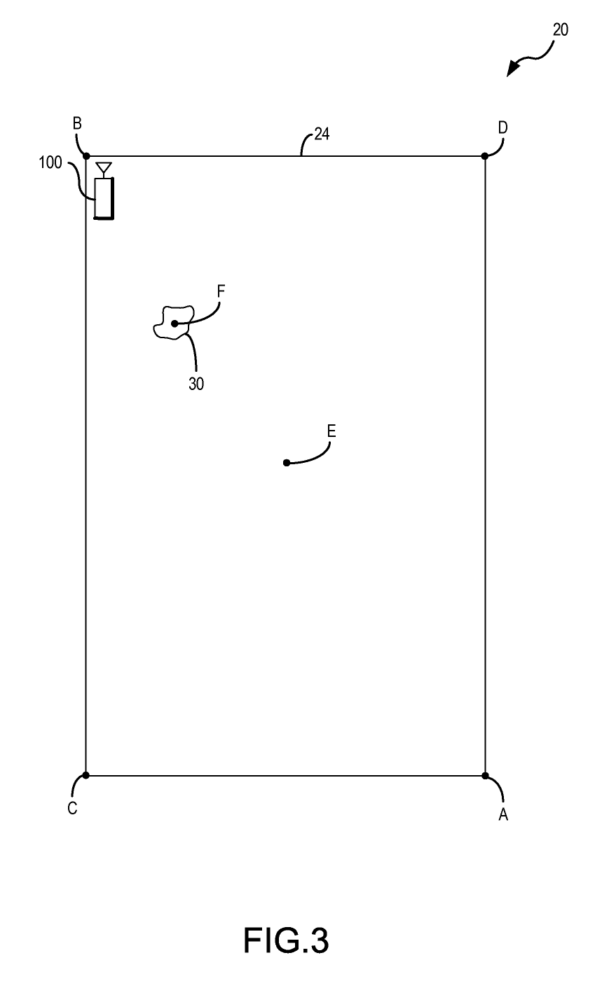

FIGS. 1-3 illustrate a virtual game playing area 20 and an associated obstacle and a wireless communications device located at various points therein. With reference to FIG. 1, the playing area 20 is defined by boundary 24 having four corner points A-D, and a center point indicated in the illustration at point E. An obstacle 30 is located within the boundary 24 and has a center point indicated at F. FIGS. 2 and 3 illustrate a wireless communications device 100 located at different positions within the playing area boundary 24. Such a playing area 20 may be an area in which a virtual reality game is to be played by several users having wireless communications devices 100. The wireless communications device 100 illustrated in FIGS. 2 and 3 may have a position detection component located therein, such as a global positioning system (GPS) receiver. The position determination component determines a position of the wireless communications device at periodic intervals, or when directed by a user of the device. While a wireless communications device 100 utilizing a GPS receiver is described in various embodiments herein, it will be understood that the wireless communications device may use any of the various positioning technologies available to such devices and/or combinations of different positioning technologies. As is well understood, there are various methods for determining position of wireless communications devices, which can be divided into two major categories, namely, network based and handset based positioning.

Network based positioning uses the mobile network that communicates with the wireless communications device in conjunction with network based position determination equipment (PDE) which is used to determine a position of the wireless communications device. Such network based positioning may use any of a number of different positioning techniques, including, for example, cell of origin (COO) or cell ID of the corresponding cell site currently serving a particular wireless communications device, angle of arrival (AOA) of a signal between the wireless communications device and one or more wireless base stations, time of arrival (TOA) of signals between the wireless communications device and one or more wireless base stations, and various radio propagation techniques which commonly use previously determined mapping of radio frequency characteristics to determine an estimate of a position of the wireless communications device. Furthermore, hybrid methods of such network based positioning may also be used which combine one or more different methods. Additionally, network based positioning may be used in other types of networks, such as wireless local area networks.

Handset or wireless communications device based positioning technology uses the wireless communications device itself as the primary means of positioning the wireless communications device, although the wireless communications network may be used to provide assistance in acquiring the wireless communications device and/or making position estimate determinations based on measurement data and wireless communications based position determination algorithms. Such handset based positioning technology may include observed time difference measurements at the wireless communications device, also referred to as handset based time of arrival (TOA). Previously mentioned GPS systems may also be used in which GPS satellites transmit signals which may be used by a GPS receiver within the wireless communications device to determine the position of the wireless communications device. In general, signals from satellites are generally referred to as satellite positioning system (SPS) signals, which may be from a Global Positioning System (GPS), Galileo, GLONASS, NAVSTAR, GNSS, a system that uses satellites from a combination of these systems, or any SPS developed in the future. As used herein, an SPS will also be understood to include pseudolite systems. Pseudolites are ground-based transmitters that broadcast a PN code or other ranging code (similar to a GPS or CDMA cellular signal) modulated on an L-band (or other frequency) carrier signal, which may be synchronized with GPS time. Each such transmitter may be assigned a unique PN code so as to permit identification by a remote receiver. Pseudolites are useful in situations where signals from an orbiting satellite might be unavailable, such as in tunnels, mines, buildings, urban canyons or other enclosed areas. Another implementation of pseudolites is known as radio-beacons. The term “satellite”, as used herein, is intended to include pseudolites, equivalents of pseudolites, and possibly others. The term “SPS signals”, as used herein, is intended to include SPS-like signals from pseudolites or equivalents of pseudolites. SPS systems are often enhanced by the wireless communications network, and position determination using such systems is referred to as assisted SPS, or assisted GPS. Additionally, the SPS system may be located externally to the handset, and that communicates with the handset through USB, bluetooth, or a serial connection, for example.

Referring again to FIGS. 1-3, in one embodiment a wireless communications device 100 enabled with a position determination component is used to mark various points along the area boundary 24 in order to set the boundary. For example, as illustrated in FIG. 2, the wireless communications device 100 may be carried by a user to position A of the area boundary 24. Position A represents a corner of the playing area boundary 24 in this example. A user, using an application that is running on the wireless communications device 100, indicates that the wireless communications device is located at a point along the playing area boundary. The wireless communications device 100 then determines the position, using any of the position determination components that may be used in such a device, and associates this position with the point along the playing area boundary 24. A user may then carry the wireless communications device to another point along the playing area 24, illustrated in FIG. 3. The wireless communications device 100 is located at point B. The user may then provide an indication to the wireless communications device that a second point along the playing area boundary 24 is to be marked. In one embodiment, the user, after marking points A and B, may provide an indication on the wireless communications device that the two marked points represent opposite vertices of the diagonal of the playing area boundary 24, thus an application running on the wireless communications device may determine the complete boundary 24 using this information. As will be understood, numerous different techniques may be used for defining a playing area boundary 24, such as marking each corner of the playing area boundary, marking the location of a center point E of the playing area boundary and defining a radius that is to define the playing area boundary 24, which in this case would be a circle. Furthermore, the wireless communications device 100 may be carried to different points along a non-symmetric playing area boundary 24 with different points along the playing area boundary marked in the wireless communications device in order to define the playing area boundary 24. In one embodiment, the wireless communications device 100 includes an application which provides an illustration of the playing area boundary on a user interface, thus providing the user with the ability to verify that the shape of the playing area boundary is entered correctly into the wireless communications device and/or edit one or more areas of the boundary. An area of the boundary may be edited, in such an embodiment, directly on the user interface of the wireless communications device 100, or by designating a portion of the boundary to be changed and marking the new boundary location(s) with the wireless communications device 100 as described above.

Furthermore, the wireless communications device 100 may be used to mark one or more obstacles 30 that are located within the playing area boundary 24. In the embodiments of FIGS. 1-3, obstacle 30 is located within the playing area boundary 24 and has a center point associated therewith. A user may carry the wireless communications device 100 to point that is in close proximity to the obstacle 30 and mark the position of the obstacle using the position determination component of the wireless communications device. In this manner, the location of one or more obstacles within the playing area boundary may be marked and used when performing operations related to a virtual reality game, for example. For large obstacles, such as a building or other relatively large area, a user may outline the perimeter of the obstacle by carrying the wireless communications device around the perimeter with the location of the wireless communications device monitored continuously or near continuously to mark the location of the perimeter.

By way of example, in one embodiment various different users may be participating in a virtual reality game that is to be played within playing area boundary 24. The playing field of the game may be designated, for example, by one of the users as described above, and the boundaries and obstacle information provided to the other users through wireless communications with the other users, or through a server, as will be described in more detail below. A tree is also located within the playing area boundary 24 and corresponds to obstacle 30 in the illustrations of FIGS. 1-3. The tree, and any other obstacles, may thus be used to constructively interact with the virtual reality game. When users are playing the virtual reality game, they continue to carry the wireless communications devices 100 that monitor the location of the users, and in the event users exit the playing area boundary 24, one or more types of alerts may be generated by the wireless communications device indicating that the position of the user is outside of the playing area boundary 24. Similarly, if a user comes within a certain proximity of an obstacle 30 within the playing area boundary, the wireless communications device may generate one or more alerts based on the location of the user. As is understood, position determination systems often include an error calculation that may be used to estimate an error in the calculated position of an SPS receiver. In cases where estimated position error is relatively high, this error estimate may be used to determine the probability that any given boundary is exceeded or not, and alerts generated based on such probability. Furthermore, in some embodiments, the location of one or more obstacles 30 may be dynamic, thus moving around within the playing area boundary. For example, the obstacle 30 may be associated with one of the players of the virtual reality game, and in the event that another player of the virtual reality game comes within a predefined proximity of the obstacle, an event may happen to the second player. Similarly, the obstacle 30 may be a static obstacle and represent a hazard within the playing area boundary, such as a hole or a water hazard, and thus players carrying wireless communications devices 100 are alerted in the event that they come within a certain proximity of the obstacle 30, and may thus avoid the obstacle.

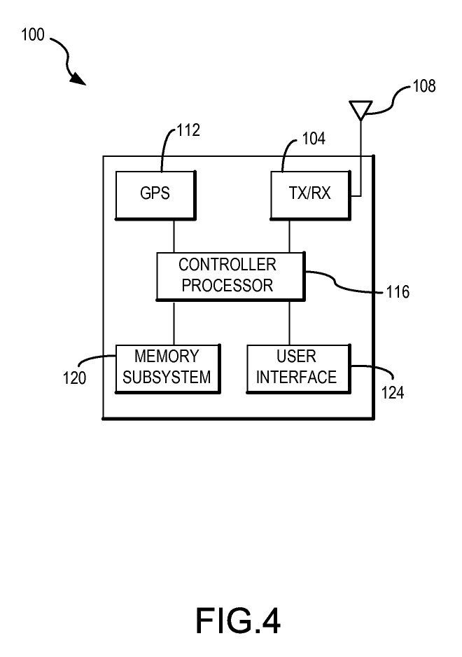

Referring now to FIG. 4, a block diagram illustration of a wireless communications device 100 of an embodiment is now described. In this embodiment, the wireless communications device 100 includes various components that are used in the operation of the device. The wireless communications device 100 may also be referred to as a mobile or remote station. As used herein, wireless communications device refers to a device such as a cellular telephone, user equipment, laptop computer, or other personal communication system (PCS) device. Wireless communications device may communicate with one or more of various types of communication networks, such as a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be used for any combination of WWAN, WLAN and/or WPAN.

With continuing reference to FIG. 4, the wireless communications device 100 of this embodiment includes is a transmitter/receiver portion 104 that is connected to an antenna 108 and is used to send and receive wireless signals to/from one or more wireless base stations (not shown). While the transmitter/receiver 104 is illustrated in this Figure as a single component, it will be understood that the transmitter/receiver 104 may include one or more different components that perform transmitting and/or receiving functions. Similarly, while a single antenna 108 is illustrated, it will be understood that one or more different antennas 108 may be included in such a wireless communications device 100. A GPS receiver 112 is included in the wireless communications device and is used to determine the position of the wireless communications device as required. The GPS 112 may be connected to antenna 108 to receive the signals from one or more GPS satellites, or may have a separate antenna that is separate from the antenna 108. While illustrated as a GPS 112, the wireless communications device may include any of the other types of position determination systems as described above, and/or combinations of different position determination systems may be used. A controller 116 is connected to the transmit/receive component 104 and the GPS receiver 112. The controller 116 receives position information from the GPS receiver 112 and provides signals to the transmit/receive component 104 to be modulated and transmitted to the wireless network. Similarly, the controller 116 receives signals from the transmit/receive component 104 that have been received from the wireless network. A memory 120 is connected to the controller 116 and is used to store various programming instructions, and any other information required to be stored in the wireless communications device 100. The memory 120 may include static and/or dynamic memory which may be volatile and/or non-volatile. A user interface 124 is also connected to controller 116 and is used for interfacing with a user through a keypad, a visual display, and/or an audio interface.

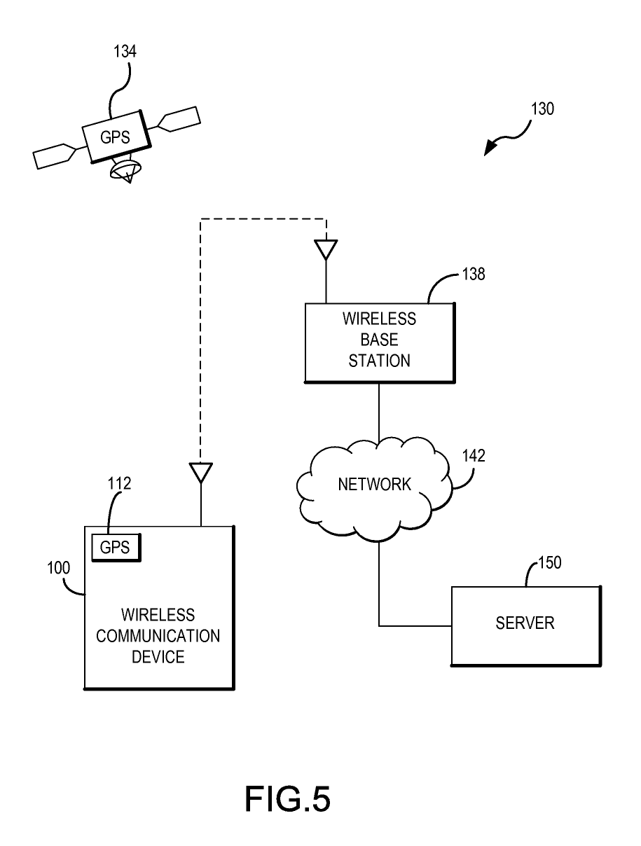

Referring now to FIG. 5, a system 130 of an embodiment is now described. In this embodiment, the system 130 includes a wireless communication device 100 that includes a position determining sub-system such as a GPS system 112 that receives signals from GPS satellites 134. Similarly as described above, any suitable position determination system may be used, and a GPS 112 is described here for the purposes of illustration and discussion. Furthermore, as is well understood, GPS positioning is determined by receiving signals from several GPS satellites 134 using known trilateration techniques, with the number of satellite signals required determined by the type of positioning being done, and whether any positioning assistance is provided by the wireless communication network or other entity. The wireless communication device 100 communicates with one or more wireless base stations 138. In one embodiment, the wireless communications device 100 and wireless base station 138 communicate using code division multiple access (CDMA) techniques, although any available wireless communication technique may be used as discussed above. The wireless base station 138 is interconnected with a network 142, which may include a public switched telephone network (PSTN), local area network, and/or wide area computer network, for example. In the embodiment of FIG. 5, a server 146 is also interconnected with the network 162.

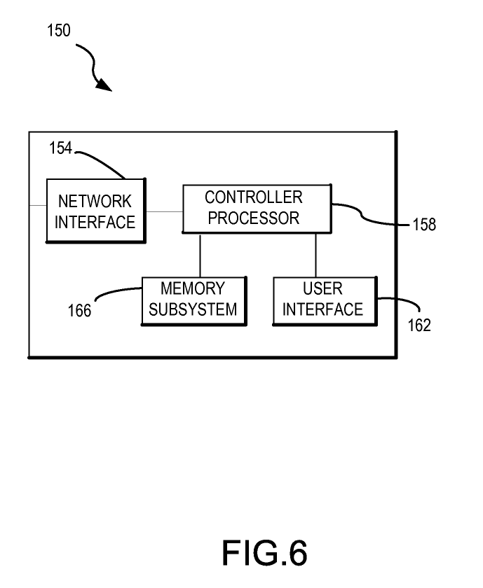

Referring now to FIG. 6, a block diagram illustration of a server 150 of an exemplary embodiment is now described. In this embodiment, the server 150 includes a network interface 154 that is used to interconnect the server 150 and the network 142 (FIG. 5). A controller processor 158 executes various applications as necessary for the operation of the server 150, including applications that interface with various different wireless communications devices, and in some embodiments also executes applications that perform position determination for wireless communications devices or provide assistance information to wireless communications devices to assist in position determination. The server 150 includes a user interface 162 that provides a user, or system administrator, an interface to the server 150. The server 150 also includes a memory 166 that may be used to store code for various different application that are executed by the controller processor 158, and also to store any data or other information related to the operations of various wireless communications devices, including boundary and obstacle information for one or more areas for virtual operations of wireless communications devices.

In various embodiments, systems such as illustrated in FIG. 4-6 may be used in a number of different applications. One embodiment provides a virtual reality game in which players carry a wireless communications device 100 with positioning capability. The wireless communications device 100 communicates position information to the server 150, and various events within the virtual reality game are triggered by the particular location of the wireless communications device 100. For example, players may agree to play a virtual reality game in a designated area. In one embodiment, the wireless communications device 100 determines its position using SPS positioning and reports this position to the server 150 through the wireless base station 138 and the network 142. The server 150 performs any required functions to allow various players, each having a wireless communication device 100 in communication with the server 150, to interact in the virtual reality game. For example, a player carrying a wireless communications device 100 may be directed by software running at server 150 to make certain moves or perform certain acts to act out the virtual reality game, based on the position of the player reported by the wireless communications device 100. Furthermore, when the position of one or more obstacles is marked within the virtual reality playing area, the server may communicate a warning to the wireless communications device 100 to indicate to the player that the obstacle is nearby or that the player has entered into an “off-limits” area that is associated with the obstacle.

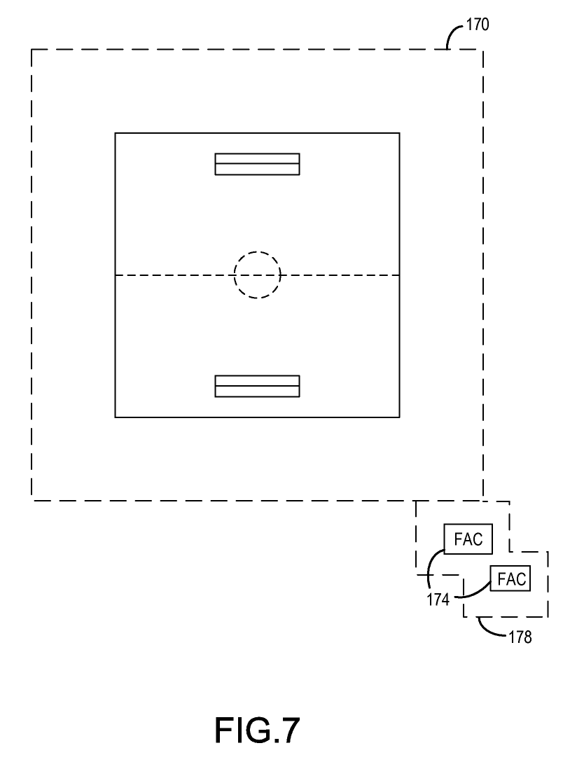

In another embodiment, illustrated in FIG. 7, a child may carry a wireless communications device 100 while attending an event, such as a soccer game. A parent may identify a boundary 170 associated with the grounds of the event. Such a boundary 170 may be established in a similar manner as described above with respect to FIGS. 1-3. For example, corners of the event site may be marked, or opposing corners marked with the wireless communication device determining the complete boundary by completing a rectangular boundary based on the opposing corners. In addition, a boundary associated with a particular site may be stored at a server, and when the wireless communications device is at a site a query may be communicated to the server to determine if boundaries for that particular location have been stored with the server. If such a stored boundary is present, the server may communicate the boundary to the wireless communication device. A user, is some embodiments, may view a representation of the boundary, such as on a map or illustration of the local area, and verify that the boundaries are correct. A user may also be able to edit one or more sections of the boundary if desired, such as by editing directly on the wireless communications device, or by designating a boundary to be changes and marking a new boundary as described above. In the event that a boundary is not stored at the server for the particular site, the boundary may be set using one of the previously described techniques. Such a boundary may be recorded on one wireless communications device for use on multiple devices. Furthermore, in the illustration of FIG. 7, a facility 174 is located adjacent to the playing field and at a location that is beyond the boundary 170. In this embodiment, an exception to the boundary 170 may be established, illustrated as 178 in FIG. 7. Such an exception 178 may be set in a similar manner as described above with respect to marking the location of an obstacle. In the embodiment of FIG. 7, a parent may desire that their child have access to the facility 174 even though it is beyond the perimeter of the boundary 170. Such a facility 174 may include, for example, a restroom and concession stand. The exception boundary 178 may be set, for example, by marking the location of the facility 174 using the wireless communications device, and then marking the exception boundary 178 in any suitable manner, such as one of the manners as described above. Using the example of FIG. 7, the exception boundary 178 is an asymmetrical boundary that is set to encompass the buildings associated with the facility 174. In other embodiments, the exception boundary 178 may be set by identifying a location of a facility, and then the exception boundary is set to be a predefined shape around the marked location, and that overlaps the boundary 170. Such a predefined shape may be a rectangle or circle based on the marked location that sets the exception boundary at a predefined (or user definable) distance, such as 10 meters, from the marked location. Similarly as described above, in some embodiments a server that has stored boundary information may also have exception information included. In this manner, the wireless communication device carried by the child may generate an alert when the child leaves the boundary, with the alert being generated at the child's wireless communication device, and/or one or more other wireless communications devices, such as a device carried by a parent.

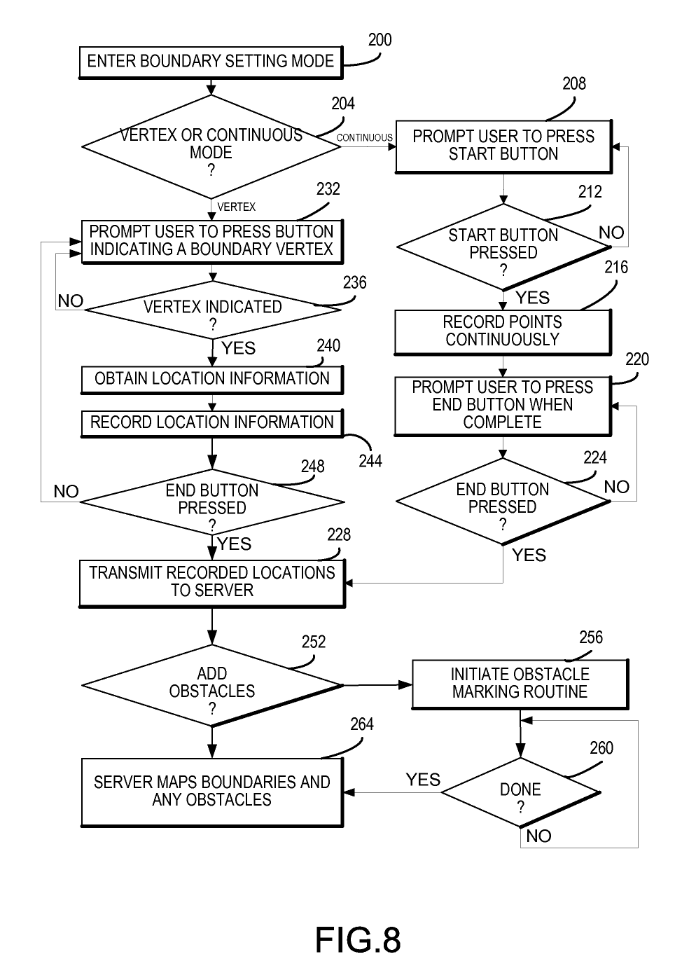

Referring now to FIG. 8, a flow chart diagram illustrating the operational steps of an exemplary embodiment is now described. In this embodiment, a wireless communications device includes an application, which may be stored in the memory of the wireless communications device, that a user may execute to enter boundary information for virtual operations, such as a virtual reality game. Initially, as illustrated at block 200, the operations begin when a boundary setting mode may be entered on the wireless communications device. It is noted that while the operations described with respect to FIG. 8 are described as being executed on the wireless communications device, it will be understood that such operations may be also conducted on a server, and that when the wireless communications device enters the boundary setting mode, a communications link between the wireless communications device and server is established and some or all of the operational steps may be performed by the server. In the embodiment of FIG. 8, the boundary setting mode includes an application that is resident on the wireless communications device, and provides an interface with a user to a graphical, audio, and/or physical interface. The wireless communications device may display information related to the boundaries for the virtual operation, as well as various other prompts, on a visual display such as a display screen that is typically present on such a device, with the information displaying a graphical format such as a map, a text format, and/or a combination of graphical and text formats. The display screen may also be used to mark boundaries on the screen, such as marking points on a map of the area, and the various points may be verified by a user carrying the device to the points to confirm that the position of the points are acceptable. The display screen may also include a touch screen where a user may provide input through the display screen by depressing a portion on the display screen associated with various prompts. Such touch-type screens are well known, and often a user utilize a stylus or other device to accurately depress a desired area on the screen. The wireless communications device may also provide information through an audio interface such as a speaker integrated within the device, or a headset worn by a user and linked (through a cable or wirelessly) to the wireless communications device. The user may also provide input to the wireless communications device through voice commands that are picked up by a microphone within the wireless communications device or headset microphone linked to the wireless communications device. Furthermore, the wireless communications device may include a physical input such as a keypad, where a user may provide input to the device. Such a keypad may be integrated with the wireless communications device, or separated from the wireless communications device and interacted through a wire or wireless link. Such a wireless communications device may also, in some embodiments, provide a physical stimulus to a user, such as through a vibrating device.

With continuing reference to FIG. 8, the wireless communications device at block 204 provides a prompt to a user to enter a boundary setting mode. In this embodiment, the boundary may be set using a continuous mode or a vertex mode. In a continuous mode, the location of the wireless communications device is continually monitored while the user travels around the circumference of the area to be included within the boundary. In a vertex mode, the user enters one or more vertices that define the vertices of the area to be included. At block 204, it is determined if the user desires to enter the vertex or continuous mode. If the continuous mode is selected, the user is prompted to press a start button, as indicated at block 208. The user may depress the start button, or any other button to indicate that the user is ready to begin traveling around the circumference of the area to be included in the boundary. At block 212, it is determined if the start button is pressed. If the start button has not been pressed, the operations of blocks 208 and 212 are continued. When the start button is pressed, as noted at block 216, the location of the wireless communications device is recorded continuously. In one embodiment, the location is determined from the GPS receiver that is incorporated within the wireless communications device, and the location from the GPS receiver is sampled at a relatively high sampling rate in order to determine a continuous boundary as the user moves along the boundary. At block 220, the user is prompted to press the end button when the user has completed the traveling around the boundary. At block 224, it is determined if the end button has been pressed. In the event that the stop button has not been pressed, the operations of blocks 216 and 224 are continued. If the end button has been pressed at block 224, the wireless communications device, transmits the recorded locations to a server, as noted at block 228.

If, at block 204, it is determined that a vertex mode has been entered. The wireless communications device generates a prompt for the user to press a button indicating a boundary vertex, as indicated at block 232. The prompt may provide an indication to the user to move to a point that represents a boundary vertex, and then press the button indicating that the user is at such a vertex. In this manner, the user may move to, for example, a corner of the boundary and provide an indication that the user is at the corner and thus the location of the corner should be marked. At block 236, it is determined if the indication has been received that the user is at a boundary vertex. If such an indication has not been received, the operations of block 232 are continued. When the indication that the user is at a vertex has been received, the wireless communications device obtains location information, as noted at block 240. This location information is recorded at block 244. At block 248, it is determined if the end button is pressed, indicating that the user has completed entering vertex information. If the end button has not been depressed, the operations starting at block 232 are repeated. If the end button has been pressed, the wireless communications device transmits the recorded locations to a server, as noted at block 228. Following the transmission of the recorded locations defining the boundary, it is determined if obstacles need to be added to the boundary, as indicated at block 252. If obstacles are to be added, the wireless communications device initiates an obstacle marking routine, as noted at block 256. At block 260, it is determined if the obstacle marking is complete, and when the obstacle marking is complete, the server maps the boundaries and any obstacles, as noted at block 264.

When the server maps the boundaries and any obstacles, any one of a number of mapping routines may be utilized. For example, if the location points were recorded in a continuous mode, the user may have deviated from a straight line, or smooth arc, as they traversed the boundary. In such instances, a smoothing program may be used to smooth the boundaries in order to reduce or eliminate any consistencies in the boundary that may result from a literal mapping of the user's movements. Similarly, if the location points are entered in a vertex mode, the boundary may be mapped by drawing lines between each of the vertices that were recorded, and then performing normal corrections such as adjusting a location of one or more vertices to provide a 90 degree angle between boundary segments, for example, if the boundary is to be rectangular. Furthermore, when the boundary information is set in a vertex mode, the wireless communications device may provide further prompts for a user to enter definitions related to a boundary. For example, if the boundary is to have a defined shape, such as a square or rectangle, this may be entered. Furthermore, the boundary may have a circular or oval shape, or certain segments of the boundary may be connected with an arc rather than straight line. In any event, the server receives this relevant information and determines boundaries in accordance therewith. While the above describes that the server maps the boundaries, and any obstacles associated with a playing area, such boundary/obstacle mapping may also be done at the wireless communications device.

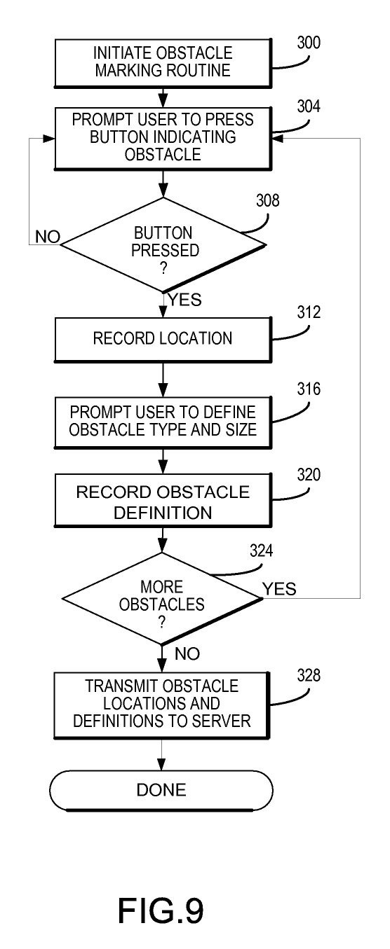

With reference now to FIG. 9, an obstacle marking routine in an exemplary embodiment is now described. In this embodiment, the obstacle marking routine is initiated as noted at block 300. Such an obstacle marking routine may be initiated by the wireless communications device in boundary setting mode after a user has been prompted regarding whether any obstacles are present within the boundary. Such an obstacle marking routine may also be entered separately from the boundary setting mode such as, for example, when a user desires to enter obstacle information after the boundary of the virtual area has already been set. Furthermore, while the routine of FIG. 9 is descried with reference to one or more obstacles, such a routine may be used to mark and desired exception to the boundary of the area for virtual operations. When the routing in entered, at block 304, the user is prompted to press a button indicating an obstacle. In this embodiment, the user moves to the location of the obstacle and depresses the button to indicate they, and the wireless communications device, are at the location of the obstacle of interest. At block 308, it is determined if the obstacle indication has been pressed. If the button has not been pressed, the operations of block 304 are continued. When the user depresses the button indicating an obstacle, the wireless communications device, at block 312, records the location of the obstacle. At block 316, the wireless communications device then prompts the user to define the obstacle by prompting the user to enter a type of obstacle, size of the obstacle, and/or other identifying information related to the obstacle, such as a category of obstacle, and/or function that the obstacle may have in virtual operations, such as a virtual reality game (e.g. no travel zone, etc.). For example, if the obstacle is a tree, the user may provide such an indication along with a size of the tree. The obstacle definition may also include a default buffer zone around the obstacle, in order to ensure that the obstacle is physically within the obstacle location as defined in the obstacle marking routine. The obstacle definition may also be entered by entering into a continuous marking mode, similarly as described with respect to FIG. 8, in which a user walks around the circumference of the obstacle while the wireless communications device continually records location points in order to properly map the obstacle location and size. Furthermore, when marking an obstacle in a virtual reality game, a user may mark a playing area such as by walking around a virtual outline of a castle, and the dungeon within the castle, for example. Thus, when marking obstacles, such obstacles may also include virtual objects and definitions related to those objects. At block 320, the obstacle definition is recorded. The user is then prompted, at block 324, as to whether additional obstacles exist that need to be marked. In the event that additional obstacles are present, the operations beginning at block 304 are repeated. In the event that additional obstacles are not present that need to be marked, the wireless communications device transmits the recorded obstacle location information and definition information to the server, as noted at block 328. At block 332, the operations of the obstacle marking routine are completed. In other embodiments, obstacles and/or features may be entered after the server has received the relevant information and determined boundaries and obstacle and/or exception locations. For example, if a new obstacle is discovered during the course of the virtual operations, a user may provide an input to the wireless communications device indicating the obstacle, and the wireless communications device may perform the appropriate obstacle marking routine.

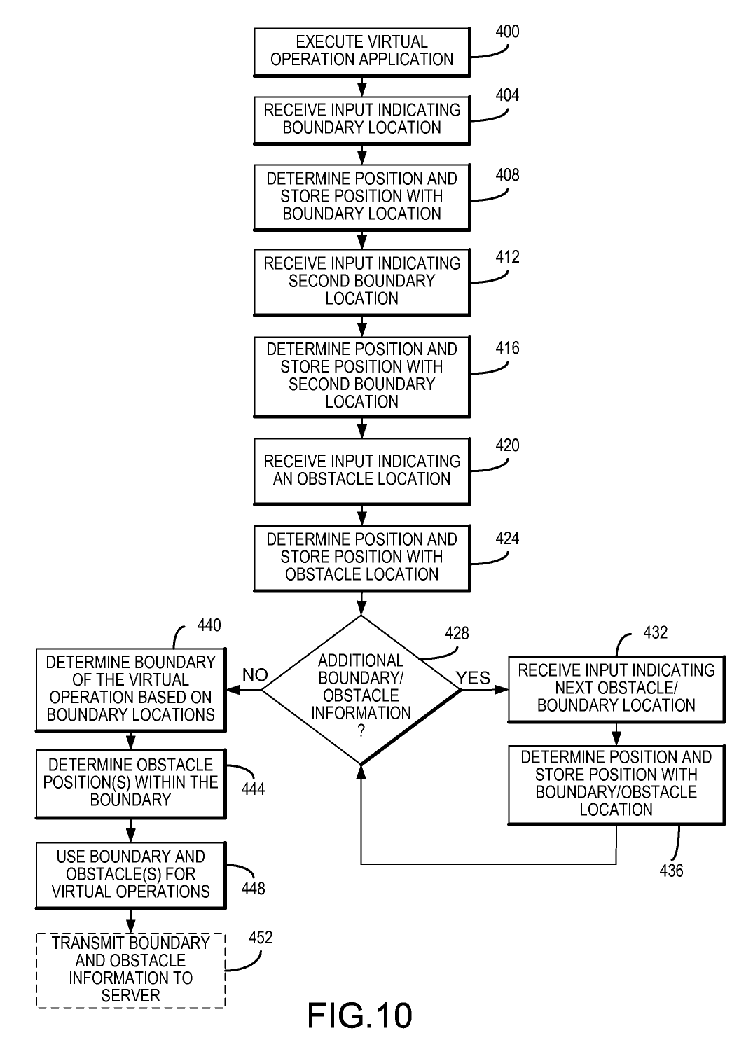

Referring now to FIG. 10, a flow chart diagram illustrating the operational steps for another embodiment is now described. In this embodiment, a user with a wireless communication device desires to participate in a virtual reality operation, such as a virtual reality game. Initially, as illustrated at block 400, the operations begin when a virtual operation application is executed. The virtual reality operation may be executed using an application that is resident on a wireless communications device, and is executed on the wireless communications device providing an interface with a user through a graphical, audio, and/or physical interface. Alternatively, the application may run on a server that is in communication with the wireless communications device and receives input from the wireless communications device and provides responses from the application to the wireless communications device. Furthermore, applications may run on both the wireless communications device and the server that divide processing tasks between the device and server. The wireless communication device may display information related to the virtual operation on a visual display such as a display screen that is typically present on such a wireless communications device, with the information displayed in a graphical format, such as a map, a text format, and/or a combination. The display screen may also be a touch-type screen, where a user may provide input through the display. Such touch-type screens are well known, and often a user utilizes a stylus to accurately depress a desired area on the screen. The wireless communications device may also provide information through an audio interface such as a speaker integrated within the device, or a headset worn by a user and linked (through a cable or wirelessly) to the wireless communication device. The user may also provide input to the wireless communication device through voice commands that are picked up by a microphone within the wireless communications device or a headset linked to the wireless communications device. Furthermore, the wireless communications device typically includes a physical input, such as a keypad, where a user may provide input to the device. Such a keypad may be integrated with the wireless communications device, or separate from the wireless communications device with the device and keypad interconnected through a wired or wireless link. Such a wireless communications device also, in some embodiments, provides a physical stimulus to a user, such as through a vibrator.

Referring still to FIG. 10, the wireless communications device, at block 404, receives an input indicating a boundary location. A user provides such an input, in some embodiments, when the user is located at a particular boundary location and is carrying the wireless communications device. At block 408 the wireless communications device determines a current position, and stores this position with the indicated boundary location. The wireless communications device then, at block 412, receives an input indicating a second boundary location. A user, in some embodiments, may provide such an input after moving to the second boundary location and providing an appropriate input to the wireless communications device. At block 416, the wireless communications device determines a current position and stores this position with the indicated second boundary location. The wireless communications device receives an input indicating an obstacle location, as indicated at block 420. Such an input may come from a user carrying the wireless communications device when the user is standing adjacent to the obstacle. At block 424, the position of the wireless communications device is determined and this position is stored with the obstacle location. The application that receives the input indicating an obstacle, in one embodiment, also prompts the user for additional information, such as a size and general geometric shape of the obstacle. In other embodiments, a default size of an obstacle may be set, with a user then having an option to input a different value. In still further embodiments, the application prompts the user for an obstacle type and sets information related to the obstacle based on the obstacle type. For example, if the obstacle is a tree that is located within the boundary area for the virtual operation, a default perimeter may be established for the obstacle that is a set radius from the obstacle location that is stored as noted at block 424. In the case that the obstacle is a water type obstacle, the user may be prompted for additional information such as an approximate size and/or shape of the obstacle. In other embodiments, the user may input that an obstacle boundary should simply be a circle having a certain radius, or a square of a desired size that is centered at the obstacle location. In many applications, the precise location of an obstacle boundary is not required, and the user may simply enter information that will establish an obstacle boundary that provides an adequate margin to provide an alert that the obstacle boundary is approaching or has been crossed.

Still referring to FIG. 10, at block 428 it is determined if additional boundary and/or obstacle information is to be provided. If it is determined that there is additional information to be provided, an input is received indicating the next boundary or obstacle location, as indicated at block 432. At block 436, the position of the wireless communications device is determined and stored with the additional boundary or obstacle information, and the determination of block 428 is again performed. If it is determined at block 428 that no additional boundary and/or obstacle information is to be provided, the boundary of the virtual operation is determined based on the input boundary locations, as noted at block 440. Such boundary information may be determined, as discussed above, based on the received boundary location information and calculated boundary lines that connect the stored boundary locations. For example, a user may enter boundary location for each corner of a rectangular area for the virtual operation. The boundary is then determined simply by calculating the positions along straight lines that connect the corners to form a perimeter of the rectangular area. Similarly, and as also discussed above, a user may mark the location of opposing corners of a rectangular area, and the boundary is determined by calculating the positions along a perimeter of a rectangular area having such opposing corners. Furthermore, a user may mark multiple locations of an irregularly shaped boundary and positions of the boundary perimeter determined by connecting each of the sequentially marked boundary locations with a line to form a boundary perimeter. In some embodiments, an application provides a map displaying the marked boundary locations and calculated perimeter and a user may verify that the boundary is correctly drawn, or may provide additional input to more accurately define the desired boundary.

The obstacle positions within the boundary are determined at block 444. Such obstacle positions may be determined by calculating a boundary associated with each obstacle using information such as described above that provides obstacle information and locations. In some embodiments, an application provides a map displaying the boundary obstacles within the boundary, and a user may verify that the boundary and obstacles are correctly drawn, or may provide additional input to more accurately define the desired boundary, obstacle locations, and/or obstacle boundaries. At block 448, the boundary and obstacle information is used in virtual operations, such as when one or more users participate in a virtual reality game played within the boundary. A wireless communication device is carried by each user participating in the virtual operations that monitors the position of the user and provides alerts whenever a user comes within a predefined proximity of a boundary or obstacle. The wireless communications device may also provide alerts related to other events within the boundary based on the user's position within the boundary and events that are associated with that particular position as predefined by the virtual operation. At block 452, the wireless communications device optionally transmits boundary and obstacle information to a server. The server may then provide this information to other users that participate in virtual operations within that particular area. As will be understood, FIG. 10 provides one exemplary embodiment for establishing and using boundary/obstacle information in a virtual operation. Furthermore, the sequence of the operations illustrated in FIG. 10 may be modified from the sequence illustrated, and such modifications will be understood and are well within the abilities of one of ordinary skill in the art.

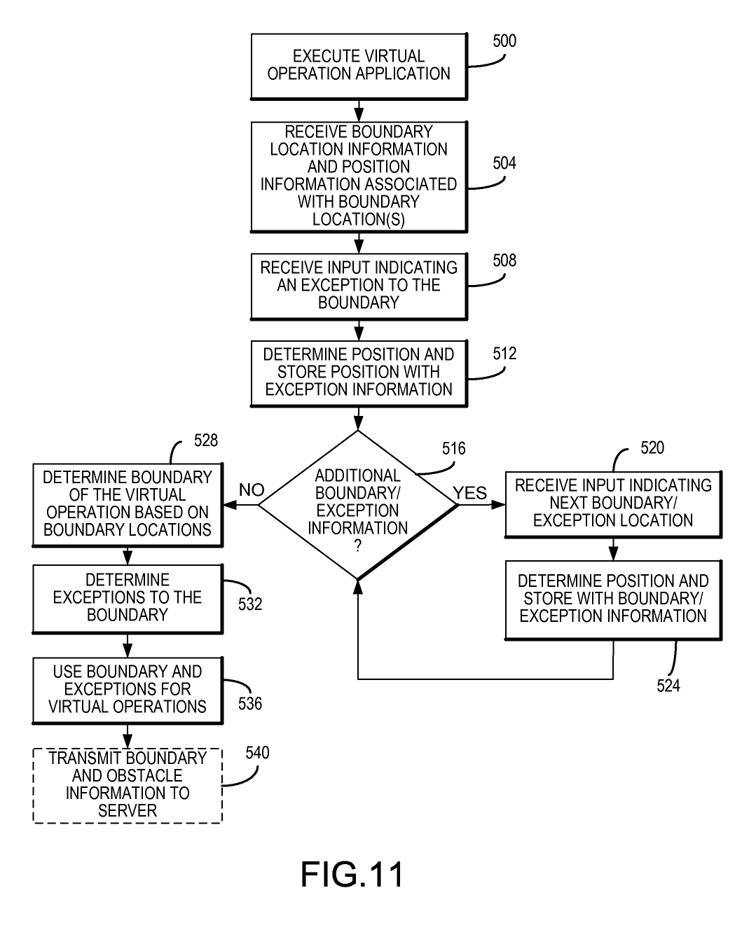

Referring now to FIG. 11, a flow chart illustration of the operational steps for another embodiment is now described. In this embodiment, a boundary is established, along with one or more exceptions to the boundary. Initially, as indicated at block 500, the operations begin when a virtual operation application is executed. The virtual reality operation may be, similarly as discussed above, executed using an application that is resident on a wireless communications device, an application that operates on a server, or a combination thereof. The wireless communications device includes a user interface, also discussed above. The wireless communications device, at block 504, receives an input indicating boundary locations. A user provides such an input, in some embodiments, when the user is located at a particular boundary location and is carrying the wireless communications device. The input of boundary locations may be performed in a similar manner as discussed with respect to FIG. 10. In the embodiment of FIG. 11, an input is provided that indicates an exception to the boundary, as noted at block 508. At block 512, the position of the wireless communications device is determined and stored along with the exception information. Such exception information may include areas beyond the boundary that are deemed to be “in-bounds” for purposes of the virtual operations. Using the example of FIG. 7, a boundary may be a perimeter around a sports playing field, and an exception may be a restroom or concession facility that is beyond the defined perimeter. Alternatively, an exception to the boundary information may be an area that is located within the defined boundary perimeter that is deemed to be “out-of-bounds” of off limits. In such a case, the exception information is similar to the obstacle information as described above. At block 516, it is determined if additional boundary and/or exception information is to be input. If additional information is to be input, the input indicating the next boundary or exception location is received, as noted at block 520. The position of the wireless communications device is determined and stored with the boundary or exception information, according to block 524, and the operations described with respect to block 516 are performed. In the event that it is determined at block 516 that no additional boundary/exception information is to be input, the boundary of the virtual operation is determined based on the boundary locations, as noted at block 528. The boundary may be determined in any suitable manner, such as one or more of the manners as described above. At block 532, exceptions to the boundary are determined. Such exceptions may be determined by calculating the locations of a perimeter that is associated with each particular exception, and storing this information for use in the virtual operation. At block 536, the boundary and exception information is used for virtual operations. For example, the position of a person carrying a wireless communications device is monitored, and an alert generated when the person moves beyond an area that is defined by the boundary and exception(s). Optionally, at block 540, the boundary and obstacle information is transmitted to a server. The server may then provide this information to other users that participate in virtual operations within that particular area. Furthermore, in some embodiments, the boundaries and/or obstacles may be dynamic, rather than static. In such cases, an obstacle may be time-varying and/or a boundary may be time-varying, thus adding an additional variable to the virtual operations. As will be understood, FIG. 11 provides one exemplary embodiment for establishing and using boundary/exception information in a virtual operation. Furthermore, the sequence of the operations illustrated in FIG. 11 may be modified from the sequence illustrated, and such modifications will be understood and are well within the abilities of one of ordinary skill in the art.

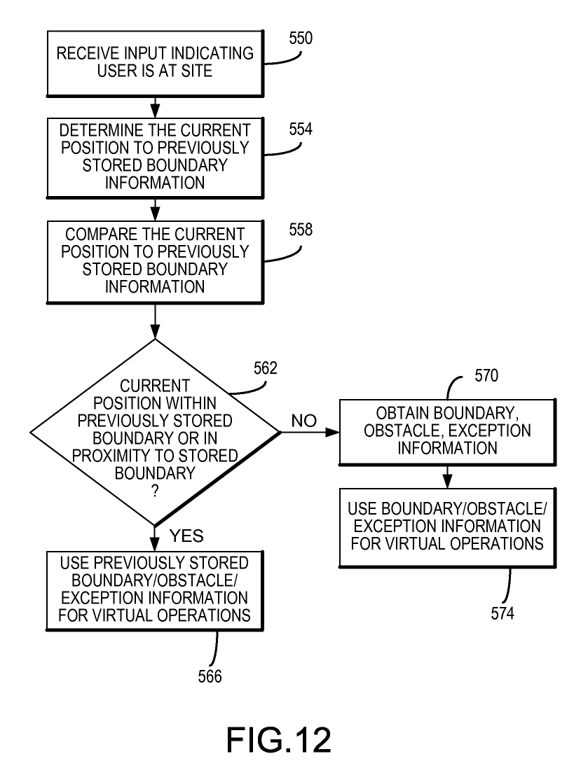

Referring now to FIG. 12, a flow chart illustrating the operations of another embodiment is now described. In this embodiment, a user carrying a wireless communications device provides an input to the device that the user is at a site of interest for performing or participating in virtual operations, as noted at block 550. The wireless communications device, at block 554, determines the current position. This current position is compared to any previously stored boundary information, as indicated at block 558. Such previously stored boundary information may include boundary and obstacle or exception information that was previously set. For example, is a user participates in a virtual reality game that is periodically played at a particular site, the boundary and obstacle or exception information for that site may be stored, and used in the future rather than having to repeat the boundary setting operations each time virtual operations are conducted at that site. At block 562, it is determined if the current position is within a previously stored boundary, or within a preset proximity to a stored boundary. In one embodiment, a user is considered to be within a preset proximity to a boundary if the current position is within 100 meters of a previously stored boundary perimeter. As will be understood, such a preset proximity may be selected based on any of a number of factors, and may be stored along with the previously stored boundary information. Such a proximity may also be set based on local conditions and/or on a proximity of two or more previously stored sites so as to avoid an overlap between two sites that may result in an incorrect boundary being selected. If it is determined that the current position is within a previously stored boundary, or within a proximity to a stored boundary, the previously stored boundary and obstacle or exception information is used for virtual operations, at indicated at block 566. If it is determined at block 562 that the current position is not within a previously stored boundary and not within a preset proximity of a previously stored boundary, new boundary, obstacle or exception information is obtained at block 570. This boundary and exception or obstacle information is used for virtual operations, as noted at block 574. Optionally, the new boundary and associated information may be stored for future use and/or transmitted to a server for future use.

While many of the above embodiments provide examples of potential applications for establishing boundaries, obstacles and exceptions that include participating in virtual reality games or monitoring locations of persons in certain areas such as sporting fields, it will be understood that the principles, devices, and methods described herein may be used in numerous other applications. For example, a parent or guardian may provide a child with a wireless communications device that has boundary information associated with areas where the child is allowed to be, such as school grounds. In the event that the child enters into an area that was not previously authorized, the wireless communications device may generate an alert that is sent to the parent(s)/guardian and/or to the child. In other applications, a wireless communications device may be used as a virtual tour guide, providing indications when a user is in proximity of a particular point of interest. Furthermore, maps of locations may also be provided, such that a user may view a map of a shopping mall, for example. Additionally, boundaries and obstacles may be entered and used in search and rescue operations or in disaster response and recovery operations. Also, such devices and methods may be used for other uses that require virtual boundaries such as theft protection to generate an alert if a defined object leaves the defined boundary, monitoring prisoners entering prohibited boundaries and/or leaving zones that they are supposed to be in, setting exclusion zones for sex offenders, among others. It is to be understood that such additional applications are within the scope of the above-described embodiments.

An application of another embodiment provides a wireless communications device that is capable of recording historical positions over a period of time as input to define frequent locations such as frequently traveled routes, frequently visited stores, and other frequent locations for a particular user of the wireless communications device. The generation of frequent locations for a particular device may be determined by the device by monitoring locations over time and ranking the most common locations, with the location that are most common designated as frequent locations. One or more of these frequent locations may be defined as a boundary that may then be mapped to the locations for typical occurrence along with interconnecting travel routes, outside of which an alert is generated. In the event that the wireless communications device deviates from such boundaries, an alert is generated and the location of the device is noted. If the deviation occurs a number of times, and/or at a selected frequency, the deviation may be added to the frequent locations. Such information could be used, for example, by insurance companies to determine rates, and/or by companies to select advertisements to send to the device based on business proximity to historically known locations.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, firmware, or combinations thereof. To clearly illustrate this interchangeability, various illustrative components, blocks, modules, circuits, and steps have been described above generally in terms of their functionality. Whether such functionality is implemented as hardware, software, and/or firmware depends upon the particular application and design constraints imposed on the overall system. Skilled artisans may implement the described functionality in varying ways for each particular application, but such implementation decisions should not be interpreted as causing a departure from the scope of the present invention.

For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine readable medium tangibly embodying instructions may be used in implementing the methodologies described herein. For example, software codes may be stored in a memory, for example the memory 120 of wireless communications device 100, and executed by a processor, for example the controller processor 116. Memory may be implemented within the processor or external to the processor. As used herein the term “memory” refers to any type of long term, short term, volatile, nonvolatile, or other memory and is not to be limited to any particular type of memory or number of memories, or type of media upon which memory is stored.

If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A method for setting virtual representations of an area for conducting virtual operations, comprising:
setting boundaries of an area with a wireless communications device enabled with location determination capabilities; and
marking the position of at least one obstacle in the area with the wireless communications device.

2. The method of claim 1, wherein the wireless communications device is enabled with a global positioning system receiver.

3. The method of claim 1, further comprising:
transmitting the boundaries of the area and the position of the at least one obstacle to a server.

4. The method of claim 1, further comprising:
storing the boundaries of the area and the position of the at least one obstacle in a memory of the wireless communications device.

5. The method of claim 1, wherein the setting boundaries step comprises:
marking corners of the area with the wireless communications device; and
designating that the area extends in straight lines between the marked corners.

6. The method of claim 1, wherein the setting boundaries step comprises:
marking a center point of the area with the wireless communications device; and
designating a radius between the center point and the boundary of the area.

7. The method of claim 1, wherein the setting boundaries step comprises:
at least two points of the area with the wireless communications device; and
designating a relationship between the marked points and the area.

8. The method of claim 7, wherein the at least two points are opposite corners of a rectangle, and the shape of the area is designated as a rectangle in which the two points are opposite corners.

9. The method of claim 1, wherein the marking step comprises:
marking the position of at least one obstacle using the wireless communications device when the wireless communications device is located in proximity to the obstacle; and
designating a size of the obstacle.

10. The method of claim 1, further comprising:
transmitting the boundary and obstacle information from the wireless communications device to a server; and
transmitting the boundary and obstacle information from the server to at least a second wireless communications device.

11. A server apparatus, comprising:
a network interface to transmit/receive network communications signals to/from one or more base stations;
a controller operable to receive information from said network interface from at least a first wireless communications device enabled with location determination capabilities, the information from the first wireless communications device including location information along with information indicative of an area for virtual operations, the location information including information related to a boundary of the area and at least one exception associated with the area boundary.

12. The server apparatus of claim 11, wherein said location information includes information from a satellite positioning system and said information indicative of an area for virtual operations includes a description of a geometric shape of the area, and wherein said controller is further operable to determine a perimeter of the boundary of the area based on the location information and geometric shape.

13. The server apparatus of claim 11, wherein the controller is operable to run an application that receives user input from a user of the wireless communications device identifying boundary locations and determine boundary information and exception information based on said boundary locations.

14. The server apparatus of claim 13, wherein the boundary locations are corners of the area.

15. The server apparatus of claim 14, wherein the location of at least one obstacle is received at the server as an exception to the boundary.

16. The server apparatus of claim 11, wherein said controller is further operable to receive boundary and exception information from said first wireless communications device and transmit the boundary and exception information to least a second wireless communications device.

17. The system of claim 11, wherein said controller is further operable to store boundary and exception information related to the area in a memory, and transmit the information to a wireless communications device when it is determined that the wireless communications device is within the area boundary.

18. The system of claim 11, wherein said controller is further operable to store historical boundary information according to frequency of detection of the wireless communications device within a proximity of a location.

19. A wireless communications device comprising:
a location determination subsystem;
a controller operably interconnected to the location determination subsystem;
a memory operably interconnected to the controller;
wherein the controller is operable to run an application stored in the memory, the application determining the location of the wireless communications device based on the location determination subsystem that is used for designating a boundary of an area of a virtual operation, and marking at least one obstacle within the boundary.

20. The wireless communications device of claim 19, wherein the controller is operable to transmit the location information to a server, and receive an area boundary and obstacle information from the server.

21. The wireless communications device of claim 19, wherein the controller periodically transmits location information from the location determination subsystem to a server when conducting virtual operations within the area, and wherein the controller receives instruction from the server in response to the transmission of location information.

22. A computer readable medium including program code stored thereon, comprising:
program code for boundary determination based on location information provided by a wireless communications device enabled with location determination capabilities, the boundary defining an area for conducting virtual operations; and
program code for exception determination based on position information for at least one exception to the boundary.

23. The computer readable medium, as claimed in claim 22, wherein the location information provided by the wireless communications device comprises:
locations of one or more corners of a perimeter of the area for conducting virtual operations; and
information designating a geometrical shape of the area for conducting virtual operations.

24. The computer readable medium, as claimed in claim 22, wherein the location information provided by the wireless communications device step comprises:
a center point of the area for conducting virtual operations; and
information designating a geometrical relationship between the center point and a perimeter of the area.

25. The computer readable medium, as claimed in claim 22, wherein the information for at least one exception to the boundary comprises:
a position of at least one obstacle that is determined using the wireless communications device when the wireless communications device is located in proximity to the obstacle; and
a size of the obstacle.

26. A system for setting virtual representations of boundaries, comprising:
means for setting a boundary with a wireless communications device enabled with location determination capabilities, the boundary defining an area for conducting virtual operations; and
means for setting an exception to the boundary of the area with the wireless communications device.

27. The system of claim 26, further comprising:
means for transmitting the boundary of the area and the position of the exception to a server.

28. The system of claim 26, wherein the means for setting boundaries comprises:
means for designating the location of at least one point associated with the area; and
means for designating a geometrical shape of the boundary of the area in relation to the at least one point.

29. The system of claim 26, wherein the means for setting an exception comprises:
means for designating the location of an exception; and
means for designating a geometrical size and shape of the exception in relation to the at least one point.

30. The system of claim 26, further comprising:
means for monitoring the location of a wireless communications device when conducting virtual operations in the area; and
means for generating an alert when the location of the wireless communications device is outside the boundary or within a preset proximity to the exception.
